(19) United States
(12) Patent Application Publication
(10) Pub. No.: US 2009/0029202 A1
(43) Pub. Date: Jan. 29, 2009

(54) FUEL CELL USING DEUTERIUM

(75) Inventors: Tim Z. Hossain, Austin, TX (US); Daniel E. Posey, Granite Shoals, TX (US)

Correspondence Address: AMIN, TUROCY & CALVIN, LLP, 127 Public Square, 57th Floor, Key Tower, CLEVELAND, OH, 44114, US

(73) Assignee: SPANSION LLC, Sunnyvale, CA (US)

(21) Appl. No.: 11/829,135

(22) Filed: Jul. 27, 2007

(51) Int. Cl. H01M 8/14

(52) U.S. Cl. 429/16; 429/13; 429/42

(57) ABSTRACT

Disclosed are fuel cells and methods of using fuel cells involving the use of an anode input gas comprising deuterium.

### TECHNICAL FIELD

Fuel cells and methods related thereto are described. The fuel cells process deuterium in addition to or as an alternative to hydrogen.

### BACKGROUND

Fuel cells are capable of providing electrical energy from an electrochemical reaction between two reactants. Specifically, a fuel cell converts the chemicals hydrogen and oxygen into water, and in the conversion process electricity is produced. Unlike batteries, a fuel cell has an external fuel source of hydrogen gas that leads to the generation of electricity as long as hydrogen is supplied. Consequently, the fuel cell does not need electrical recharging. A typical fuel cell includes two electrodes (an anode and a cathode) and an electrolyte positioned between the two electrodes. In order to prevent direct reaction of the active material of the anode and the active material of the cathode, the electrodes are electrically isolated from each other by a separator.

In a fuel cell, the anode reactant is hydrogen gas, and the cathode reactant is oxygen from the air. At the anode, oxidation of hydrogen produces protons and electrons. The protons flow from the anode, through the electrolyte, and to the cathode. The electrons flow from the anode to the cathode through an external electrical conductor, which can provide electrical energy. At the cathode, the protons and the electrons react with oxygen to form water.

When a fuel cell is powered with pure hydrogen, the fuel cell has the theoretical potential to be up to 80% efficient. That is, the fuel converts 80% of the energy content of the hydrogen gas into electrical energy. In instances where hydrogen is supplied to a fuel cell by a reformer, impurities are often introduced into the hydrogen during the reforming process. Impurities in the hydrogen supplied to the fuel cell result in decreases in efficiency making it impossible to achieve the theoretical potential of 80% efficiency.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The subject invention provides a more powerful energy source leading to a more efficient high performance fuel cell compared to conventional hydrogen fuel cells. The fuel cells described herein consume deuterium as an energy source, which leads to better power production when compared using an equivalent amount of hydrogen.

One aspect of the invention relates to methods of using a fuel cell involving charging the fuel cell with an anode input gas containing deuterium and a cathode input gas containing oxygen.

Another aspect of the invention relates to methods of improving the voltage output of a hydrogen fuel cell involving replacing at least a portion of hydrogen in an anode input gas stream with deuterium.

Yet another aspect of the invention relates to a fuel cell containing an anode, a cathode, an electrolyte, a source of deuterium, and a source of oxygen.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIG. 1 depicts a polymer electrolyte membrane fuel cell in one embodiment of the invention.

FIG. 2 depicts an alkaline fuel cell in one embodiment of the invention.

FIG. 3 depicts a phosphoric acid fuel cell in one embodiment of the invention.

FIG. 4 depicts a molten carbonate fuel cell in one embodiment of the invention.

FIG. 5 depicts a solid oxide fuel cell in one embodiment of the invention.

FIG. 6 shows a fuel cell in one embodiment of the invention.

FIG. 7 shows a fuel cell with an optional collector in one embodiment of the invention.

FIG. 8 shows a fuel cell with an optional purifier in one embodiment of the invention.

FIG. 9 shows a fuel cell with an optional reformer in one embodiment of the invention.

### DETAILED DESCRIPTION

Replacing at least some of the hydrogen provided to a fuel cell with deuterium results in an increase in power generation by the fuel cell. The replacement of hydrogen with deuterium does not negatively impact the fuel cell because the chemical properties of hydrogen and deuterium are similar. This is because deuterium is a stable isotope of hydrogen where the nucleus contains one proton and one neutron (the nucleus of hydrogen has only one proton). At ordinary temperatures and pressures, deuterium (most commonly D₂) exists in the form of a gas. However, the electron removal properties of hydrogen and deuterium are different. The difference in electron removal properties is exploited to realize higher voltages for the fuel cell.

The difference in electron removal properties is better understood in view of the following half cell reactions.

| | | | |
|---|---|---|---|
| H₂ | → | 2H⁺ + 2e⁻ | 0.000 volts |
| D₂ | → | 2D⁺ + 2e⁻ | 0.013 volts |

The half cell reaction involving deuterium has a higher positive cell potential than the half cell reaction involving hydrogen. Consequently, the half cell reaction involving deuterium has a larger Gibb's free energy which in turn, when replacing at least some of the hydrogen provided to a fuel cell with deuterium, results in making the fuel cell operation more powerful. That is, the higher positive cell potential means higher voltage for the cell. And the larger the potential (as increased amounts of deuterium are employed), the higher the amount of power is realized out of the fuel cell.

The energy source of the fuel cells described herein contains at least some deuterium to increase the power generation by the fuel cell. That is, the input gas at the anode of the fuel cell contains at least some deuterium (or at least a portion of the hydrogen in an anode input gas stream of a hydrogen fuel cell is replaced with deuterium). In one embodiment, the anode input gas contains at least about 10% by volume deuterium (and, for example, about 90% or less hydrogen). In another embodiment, the anode input gas contains at least about 25% by volume deuterium (and, for example, about 75% or less hydrogen). In yet another embodiment, the anode input gas contains at least about 50% by volume deuterium (and, for example, about 50% or less hydrogen). In still yet another embodiment, the anode input gas contains at least about 75% by volume deuterium (and, for example, about 25% or less hydrogen). In another embodiment, the anode input gas contains at least about 90% by volume deuterium (and, for example, about 10% or less hydrogen). And in yet another embodiment, the anode input gas contains substantially pure deuterium (at least about 99.9% by volume deuterium).

The most common method for producing deuterium or heavy water at the industrial level is the treatment of ordinary water, either by distillation, electrolysis or isotopic exchange to increase the percentage of deuterium. One can also treat industrial hydrogen or the gas from ammonia synthesis, which in turn comes from the treatment of natural gas or petroleum. Deuterium itself is extracted from heavy water by electrolysis. Sources for deuterium or heavy water include the Norsk Hydro facility in Norway, the Bruce Heavy Water Plant in Ontario, Canada, and others.

The anode input gas containing deuterium and optionally hydrogen may be supplied to the fuel cell by a canister or tank. For example, a pressurized tank containing deuterium and optionally hydrogen is effective for delivering large quantities of anode input gas to a given fuel cell. A pressure regulator may be employed to ensure that the pressure of the anode input gas containing deuterium remains at an acceptable value. For example, the anode input gas containing deuterium may be charged to the fuel cell under a pressure from about ambient pressure to about 10 atmospheres. In another embodiment, the anode input gas containing deuterium may be charged to the fuel cell under a pressure from about 1.1 atmospheres to about 3 atmospheres.

The input gas containing deuterium is supplied to any suitable fuel cell capable of processing the input gas, such as a hydrogen fuel cell. General examples of suitable fuel cells include polymer electrolyte membrane (PEM) fuel cells, alkaline fuel cells (AFCs), phosphoric acid fuel cells, (PAFCs), molten carbonate fuel cells (MCFCs), solid oxide fuel cells (SOFCs), regenerative fuel cells, and the like. Fuel cells are typically categorized by the type of electrolyte contained therein.

PEM fuel cells are advantageous in that they generate electricity at ordinary temperatures, have fast start-up time, have favorable power to weight ratios, and have a tolerance for impurities. Generally, a PEM fuel cell is has a cathode and an anode separated by a solid polymer electrolyte membrane. The cathode and the anode are placed in opposite relation across the solid polymer electrolyte membrane. PEM fuel cells typically employ a noble metal catalyst or a precious metal catalyst. The fuel cell is supplied with oxygen in the air to the cathode and an input gas containing deuterium is supplied to the anode, so that oxygen and deuterium and optionally hydrogen are chemically reacted to generate electricity. FIG. 1 depicts an exemplary PEM fuel cell.

The solid polymer electrolyte membrane may be a hydrogen-permeable membrane. Examples of solid polymer electrolyte membranes include porous polymer membranes such as a polyimide membrane and a polydimethylsiloxane membrane; a metallic membrane such as Pd, Pd/Ag, Pd/Ag/Cu, V, and Nb; amorphous hydrogen storage alloys (AB₂ type and AB₅ types); porous ceramic membranes; and the like.

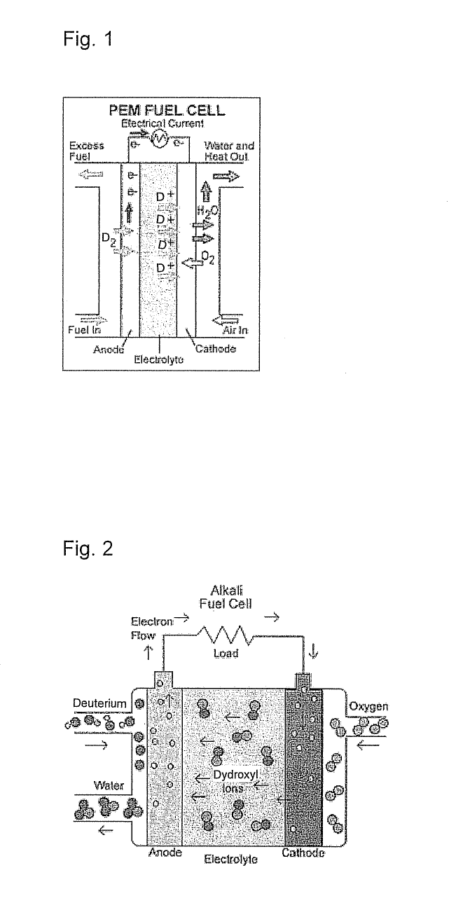

AFCs are advantageous in high performance applications. AFCs use a solution of a hydroxide compound in water as an electrolyte, and a variety of non-precious metals as catalysts at the cathode and anode. FIG. 2 depicts an exemplary alkaline fuel cell.

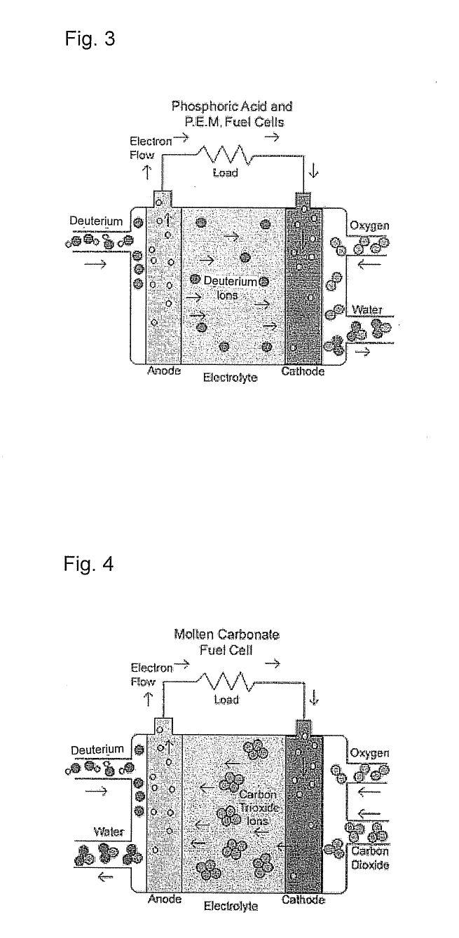

PAFCs are advantageous in that they have a high tolerance for impurities and are useful in stationary power generation applications and vehicle applications. PAFCs use liquid phosphoric acid as an electrolyte contained in a matrix between porous carbon electrodes containing a precious metal catalyst. FIG. 3 depicts an exemplary phosphoric acid fuel cell.

MCFCs are advantageous in that they operate at high temperatures, have high durability, and have high efficiencies and are useful in utility, industrial, and military applications. MCFCs have an electrolyte of molten carbonate salt suspended in a porous chemically inert ceramic matrix with non-precious metal catalysts. FIG. 4 depicts an exemplary molten carbonate fuel cell.

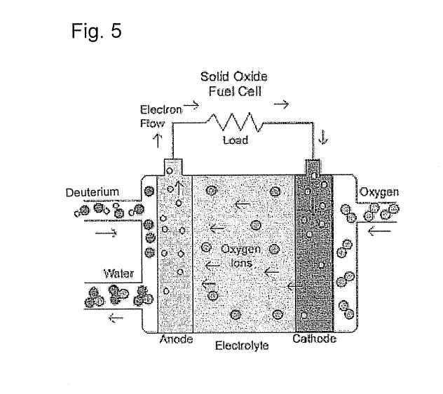

SOFCs are advantageous in that they operate at high temperatures, have are sulfur resistant, and not poisened by CO. SOFCs have a non-porous ceramic compound as the electrolyte with non-precious metal catalysts. FIG. 5 depicts an exemplary solid oxide fuel cell.

The fuel cell may optionally contain a purifier for purifying the input gas supplied to the fuel cell. The purifier removes species that are not deuterium and/or hydrogen from the input gas. A common impurity is carbon monoxide. The fuel cell may optionally contain a reformer. A reformer turns a hydrocarbon or alcohol into hydrogen, which is then fed to the fuel cell.

Regardless of the specific type of fuel cell, the components of a fuel cell generally have the following functions. The anode or negative electrode of the fuel cell conducts the electrons that are freed from the deuterium and/or hydrogen molecules so that they can be used in an external circuit. Typically, the deuterium and/or hydrogen gas is equally dispersed over the surface of a catalyst to promote the generation of electrons. The cathode or positive electrode of the fuel cell conducts the electrons back from the external circuit to a catalyst, where the electrons can recombine with the deuterium and/or hydrogen ions and oxygen to form heavy water and optionally water. An electrolyte conducts positively charged ions and blocks electrons. The catalyst(s) is a special material that facilitates the reaction of deuterium, oxygen, and hydrogen if present. Fuel cell catalysts typically contain a precious metal such as platinum, but other or additional catalytic metals may be employed.

The anode reaction, cathode reaction, and net reaction of the fuel cells described herein is as follows:

| | | | |
|---|---|---|---|
| O₂ + 4D⁺ + 4e⁻ | → | 2D₂O | cathode |
| D₂ | → | 2D⁺ + 2e⁻ | anode |
| D₂ + O₂ | → | 2D₂O | net |

In instances where a mixture of deuterium and hydrogen is employed as an anode input gas, the following anode reaction, cathode reaction, and net reaction also take place:

| | | | |
|---|---|---|---|
| O₂ + 4H⁺ + 4e⁻ | → | 2H₂O | cathode |
| H₂ | → | 2H⁺ + 2e⁻ | anode |
| H₂ + O₂ | → | 2H₂O | net |

While the catalysts at the anode and cathode are not shown in the above chemical reactions, the catalysts facilitate the above reactions.

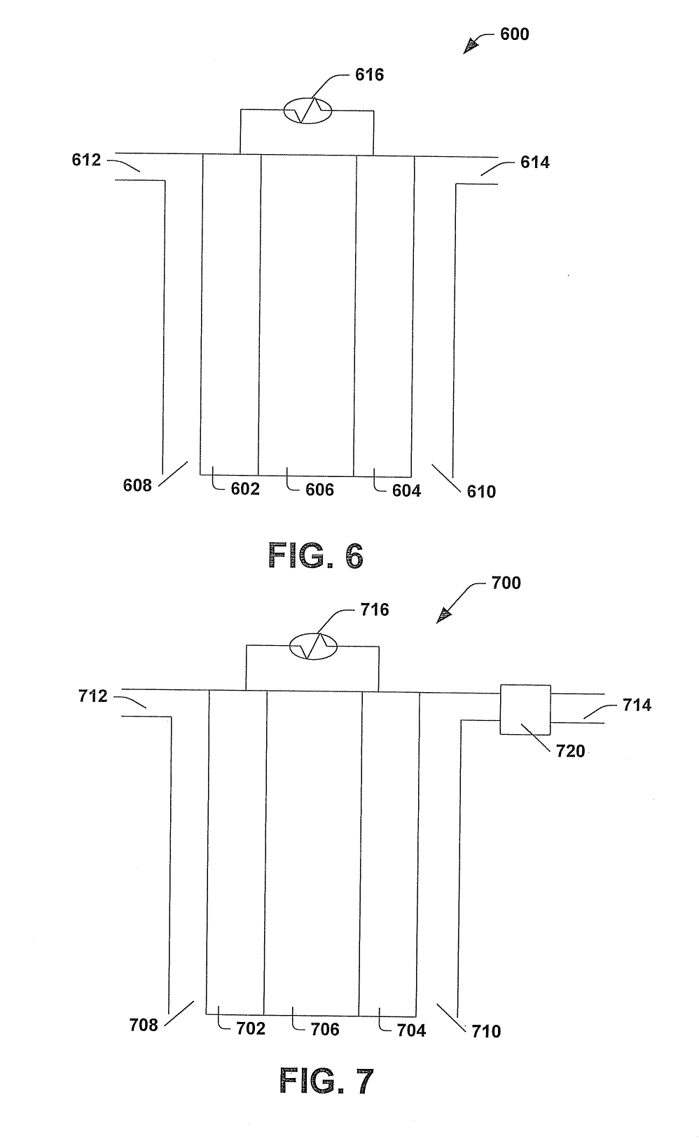

Referring to FIG. 6, a basic fuel cell 600 for using deuterium gas (D₂) is shown. Between an anode 602 and a cathode 604 is an electrolyte 606. The electrolyte may be within a membrane or other holding means. The anode 602 and cathode 604 are electrically connected by an external circuit 616. Both the anode 602 and cathode 604 may contain a catalyst. Deuterium gas enters the fuel cell at the anode input 608 on the anode side. The anode input gas may be pressurized so that the gas is forced through the catalyst by the pressure (injected at a pressure greater than atmospheric pressure). When a D₂ molecule comes in contact with the catalyst, it splits into two D⁺ ions and two electrons (e-).

The electrons are conducted through the anode 602, and travel to the external circuit 616 (where useful work such as turning a motor can occur). The electrons then return to the cathode 604. Excess deuterium gas escapes through the anode outlet 612, where it can be recycled and/or re-injected into the anode input 608.

At the cathode input 610, a cathode input gas containing oxygen gas (O₂) is forced through the catalyst, where it forms two oxygen atoms. The oxygen gas may be supplied by air, a blower, air canister, motor, or oxygen canister. At the cathode input 610, often excess air is charged (such as up to about 500% of the stoichiometric requirement of oxygen) to support the electrical current produced by the fuel cell.

The cathode input gas typically contains at least about 20% by volume oxygen. Each of the oxygen atoms has a strong negative charge. The negative charge attracts the two D⁺ ions through the electrolyte 106, where the heavy protons combine with an oxygen atom and two of the electrons from the external circuit to form a heavy water molecule (D₂O). Heavy water and oxygen-depleted air are released or discharged from the fuel cell though the cathode outlet 614. The heavy water may be captured and subjected to a subsequent use. This operation is a general example of a PEM fuel cells and PAFCs.

Referring to FIG. 6 again, the operation of AFCs, MCFCs, and SOFCs is alternatively described. Deuterium gas enters the fuel cell at the anode input 608 on the anode side and at the cathode input 610, oxygen gas (O₂) is forced through the catalyst. However, heavy water is formed on the anode side of the fuel cell, and escapes through the anode outlet 612. The heavy water may be accompanied by carbon dioxide, depending on the type of fuel cell.

The fuel cell may be made with any suitable size dimensions. The dimensions of a fuel cell are typically driven by the size of the anode and cathode. For example, the size (one dimension thereof) may be on the order of millimeters to meters.

More than one fuel cell may be arranged in series to form a fuel cell stack. Fuel stacks are employed when it s desirable to increase the voltage output. The fuel cell may further include a battery bank. The batter bank stores electrical power produced by fuel cell stack. The battery bank may include one or more batteries or other suitable devices adapted to store electrical power.

A fuel cell provides a direct current voltage that can be used to power something. Electric power generated by the fuel cell using deuterium may be converted at an inverter from direct current to alternate current, and then can be utilized to drive an electric device such as an electric motor and the like.

The fuel cell may be optionally equipped with a collector. The collector can collect heavy water (which is of much greater economic value than regular water) generated by the fuel cell resulting from processing deuterium. For example, the collector can collect heavy water so that it can be subsequently used again. The heavy water, if used to produce deuterium, can be recycled to provide additional fuel for the fuel cell.

More specifically, referring to FIG. 7, a fuel cell 700 for using deuterium gas with an optional collector 720 is shown. Between an anode 702 and a cathode 704 is an electrolyte 706. The anode 702 and cathode 704 are electrically connected by an external circuit 716. Both the anode 702 and cathode 704 may contain a catalyst. Deuterium gas enters the fuel cell at the anode input 708 on the anode side. The anode input gas may be pressurized so that the gas is forced through the catalyst by the pressure. When a D₂ molecule comes in contact with the catalyst, it splits into two D⁺ ions and two electrons (e-).

The electrons are conducted through the anode 702, and travel to the external circuit 716. The electrons then return to the cathode 704. Excess deuterium gas escapes through the anode outlet 712, where it can be recycled and/or re-injected into the anode input 708.

At the cathode input 710, a cathode input gas containing oxygen gas (O₂) is forced through the catalyst, where it forms two oxygen atoms. The cathode input gas typically contains oxygen. Each of the oxygen atoms has a strong negative charge. The negative charge attracts the two D⁺ ions through the electrolyte 706, where the heavy protons combine with an oxygen atom and two of the electrons from the external circuit to form a heavy water molecule (D₂O). Heavy water and oxygen-depleted air are captured by collector 720, while gaseous material may be discharged from the fuel cell though the cathode outlet 714. The heavy water captured may be subjected to a subsequent use.

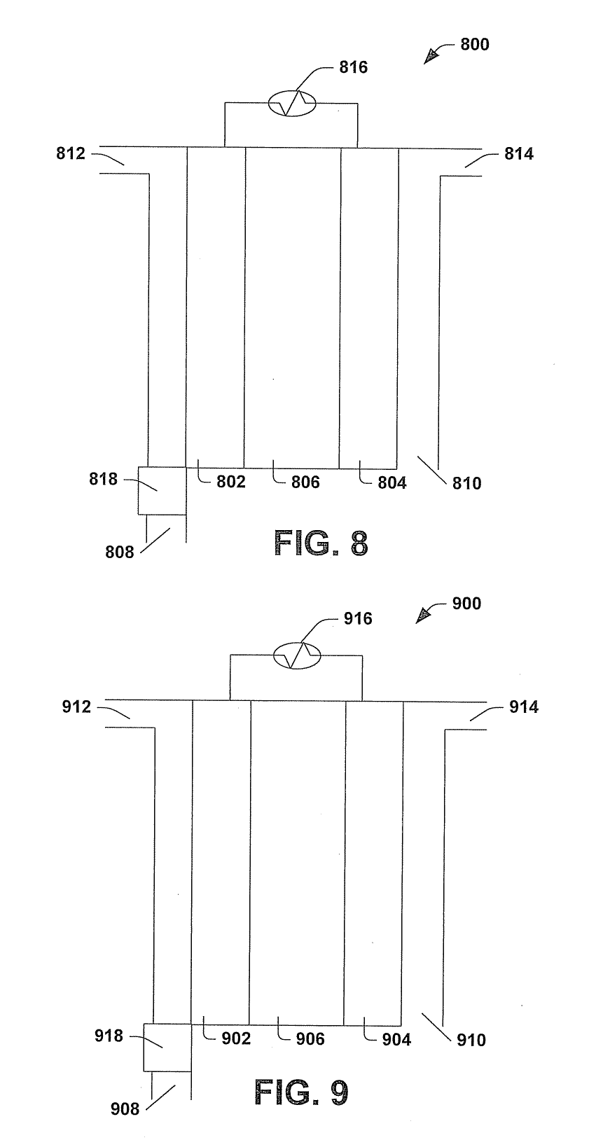

Referring to FIG. 8, another embodiment of a fuel cell 800 for using deuterium gas with an optional purifier 818 is shown. Between an anode 802 and a cathode 804 is an electrolyte 806. The anode 802 and cathode 804 are electrically connected by an external circuit 816. Both the anode 802 and cathode 804 may contain a catalyst. Deuterium gas enters the fuel cell at the anode input 808 on the anode side, passes through a purifier 818 where gaseous species that are not deuterium (and/or not hydrogen) are removed, thereby purifying the input gas. The anode input gas may be pressurized so that the gas is forced through the purifier 818 and catalyst by the pressure. When a D₂ molecule comes in contact with the catalyst, it splits into two D⁺ ions and two electrons (e-).

The electrons are conducted through the anode 802, and travel to the external circuit 816. The electrons then return to the cathode 804. Excess deuterium gas escapes through the anode outlet 812, where it can be recycled and/or re-injected into the anode input 808.

At the cathode input 810, a cathode input gas containing oxygen gas (O₂) is forced through the catalyst, where it forms two oxygen atoms. The cathode input gas typically contains oxygen. Each of the oxygen atoms has a strong negative charge. The negative charge attracts the two D⁺ ions through the electrolyte 806, where the heavy protons combine with an oxygen atom and two of the electrons from the external circuit to form a heavy water molecule (D₂O). Heavy water and oxygen-depleted air are released or discharged from the fuel cell though the cathode outlet 814.

Referring to FIG. 9, yet another embodiment of a fuel cell 900 for using deuterium gas with an optional reformer 918 is shown. Between an anode 902 and a cathode 904 is an electrolyte 906. The anode 902 and cathode 904 are electrically connected by an external circuit 916. Both the anode 902 and cathode 904 may contain a catalyst. Deuterium gas enters the fuel cell at the anode input 908 on the anode side, passes through a reformer 918 where an alcohol and/or a hydrocarbon gas is converted into hydrogen. The anode input gas may be pressurized so that the gas is forced through the reformer 918 and catalyst by the pressure. When a D₂ molecule comes in contact with the catalyst, it splits into two D⁺ ions and two electrons (e-).

The electrons are conducted through the anode 902, and travel to the external circuit 916. The electrons then return to the cathode 904. Excess deuterium gas escapes through the anode outlet 912, where it can be recycled and/or re-injected into the anode input 908.

At the cathode input 910, a cathode input gas containing oxygen gas (O₂) is forced through the catalyst, where it forms two oxygen atoms. The cathode input gas typically contains oxygen. Each of the oxygen atoms has a strong negative charge. The negative charge attracts the two D⁺ ions through the electrolyte 906, where the heavy protons combine with an oxygen atom and two of the electrons from the external circuit to form a heavy water molecule (D₂O). Heavy water and oxygen-depleted air are released or discharged from the fuel cell though the cathode outlet 914.

The fuel cells described herein can power anything that runs on electricity. Examples include vehicles such as cars, trucks, busses, motorcycles, golf carts, and bikes; appliances; portable electronics like laptop computers, radios, digital players/recorders, cellular phones, and hearing aids; toys; equipment; and the like. Generally speaking, any item that is powered by a battery can be powered by a fuel cell. Specialized high power devices and engineering prototypes are examples of items that can take particular advantage of the attributes the fuel cells described herein.

With respect to any figure or numerical range for a given characteristic, a figure or a parameter from one range may be combined with another figure or a parameter from a different range for the same characteristic to generate a numerical range.

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A method of using a fuel cell, comprising:
charging the fuel cell with an anode input gas comprising deuterium and a cathode input gas comprising oxygen.

2. The method of claim 1, wherein the anode input gas comprises at least about 10% by volume deuterium.

3. The method of claim 1, wherein the anode input gas comprises about 90% by volume or less hydrogen.

4. The method of claim 1, wherein the anode input gas comprises at least about 50% by volume deuterium.

5. The method of claim 4, wherein the anode input gas comprises about 50% by volume or less hydrogen.

6. The method of claim 1 further comprising collecting heavy water generated by the fuel cell.

7. The method of claim 1, wherein the anode input gas is charged to the fuel cell under a pressure greater than atmospheric pressure.

8. A method of improving the voltage output of a hydrogen fuel cell, comprising:
replacing at least a portion of hydrogen in an anode input gas stream with deuterium.

9. The method of claim 8, wherein the anode input gas stream comprises at least about 25% by volume deuterium.

10. The method of claim 9, wherein the anode input gas stream comprises about 75% by volume or less hydrogen.

11. The method of claim 8, wherein the anode input gas stream comprises at least about 90% by volume deuterium.

12. The method of claim 11, wherein the anode input gas stream comprises about 10% by volume or less hydrogen.

13. A fuel cell, comprising:
an anode;
a cathode;
an electrolye positioned between the anode and the cathode;
a source of deuterium coupled to the anode; and
a source of oxygen coupled to the cathode.

14. The fuel cell of claim 13, wherein the anode and cathode each comprise a catalyst.

15. The fuel cell of claim 13, wherein the source of deuterium comprises substantially pure deuterium.

16. The fuel cell of claim 13, wherein the source of deuterium comprises deuterium and hydrogen.

17. The fuel cell of claim 13, wherein the fuel cell is a polymer electrolyte membrane fuel cell.

18. The fuel cell of claim 13 further comprising a component to capture heavy water produced by the fuel cell.

19. The fuel cell of claim 13, wherein the fuel cell is selected from the group consisting of an alkaline fuel cell, a phosphoric acid fuel cell, a molten carbonate fuel cell, or a solid oxide fuel cell.

20. The fuel cell of claim 13 further comprising a recycling component for recharging unused deuterium into the fuel cell.
